(19) United States
(12) Patent Application Publication
(10) Pub. No.: US 2014/0172165 A1
(43) Pub. Date: Jun. 19, 2014

(54) ROBOT OPERATION SYSTEM HAVING A PLURALITY OF ROBOTS

(71) Applicant: FANUC CORPORATION, Yamanashi (JP)

(72) Inventor: Masaru Oda, Yamanashi (JP)

(73) Assignee: FANUC CORPORATION, Yamanashi (JP)

(21) Appl. No.: 14/086,071

(22) Filed: Nov. 21, 2013

(30) Foreign Application Priority Data
Dec. 13, 2012 (JP) 2012-272726

(51) Int. Cl. G05B 19/418

(52) U.S. Cl. CPC G05B 19/41815
USPC 700/248

(57) ABSTRACT

A robot operation system including a plurality of robots, by which a cost and/or operators of the system are reduced. The operation system includes one component supplying unit, a plurality of operation units, and a component conveying device which connects the component supplying unit and each operation unit and conveys a component supplied from the component supplying unit to each operation unit.

### BACKGROUND OF THE INVENTION

1. Field of the Invention

The present invention relates to a robot operation system having a plurality of robots, wherein each robot is configured to carry out a predetermined operation.

2. Description of the Related Art

An operation system having a plurality of robots, wherein each robot is configured to carry out a predetermined operation, is well known. For example, Japanese Unexamined Patent Publication (Kokai) No. 2003-062727 discloses assembling equipment 1, including a component supply station 2 where an operator 8 supplies components to a predetermined convey pallet 5; a component assembly station 3 where assembling robots R1 and R2 assemble the components on pallet 5; and a conveying means 4 for conveying pallet 5 from supply station 2 to assembly station 3.

Further, Japanese Unexamined Patent Publication (Kokai) No. H05-138463 discloses a method of assembling a workpiece, wherein an assembly conveying line 3 is arranged at the downstream side of a final assembly stage “S” of a pallet conveying line 1 so that line 3 extends parallel to line 1; an assembly “N” is transferred to conveying line 3 from a pallet “P” which is conveyed to the downstream side via the final assembly stage so that the orientation of assembly “N” is changed; and an assist operation for a workpiece to be assembled is carried out at a parallel convey area “A” where line 3 and line 1 extend parallel to each other.

In the assembling equipment of Japanese Unexamined Patent Publication (Kokai) No. 2003-062727, when the components are supplied to the working process using the robot, all of the components are positioned on a pallet and the pallet is conveyed by the conveying means, while the robot picks up a component required for each process so as to carry out the assembling operation. However, when various kinds or shapes of components are conveyed by means of one pallet, a creative approach is required for defining the position of each component on the pallet, whereby many pallets may be necessary.

On the other hand, in the assembling method of Japanese Unexamined Patent Publication (Kokai) No. H05-138463, a supply device is arranged in each working stage and a necessary component or jig is individually supplied to each stage. However, in such a method, an operator is required to move over a wide area and/or many operators may be necessary, in order to supply the component or jig.

### SUMMARY OF THE INVENTION

An object of the present invention is to provide a robot operation system including a plurality of robots, by which the above problems are solved and cost and/or the number of operators of the system are reduced.

According to the present invention, there is provided an operation system including a plurality of operation units, each operation unit having a robot configured to carry out a predetermined operation, the operation system comprising: one component supplying unit which supplies a component to each operation unit; and a component conveying device which connects the one component supplying unit and each operation unit and conveys the component supplied from the one component supplying unit to each operation unit.

In a preferred embodiment, the component supplying unit comprises a supplying robot which is operated by using previously stored positional information, the supplying robot being configured to transfer a component to the component conveying device.

The supplying robot may comprise a vision sensor, and the supplying robot may be operated by correcting the stored positional information based on information from the vision sensor.

As preferred examples for the component conveying device, an air-driven slider, a servo-drive slider, a slider driven by a linear motor or a belt conveyor may be used.

### BRIEF DESCRIPTION OF THE DRAWINGS

The above and other objects, features and advantages of the present invention will be made more apparent by the following description of the preferred embodiments thereof with reference to the accompanying drawings wherein:

FIG. 1 is perspective view of a robot operation system according to a first embodiment of the present invention;

FIG. 2 is a top view of the robot operation system of FIG. 1; and

FIG. 3 is a perspective view of a robot operation system according to a second embodiment of the present invention.

### DETAILED DESCRIPTION

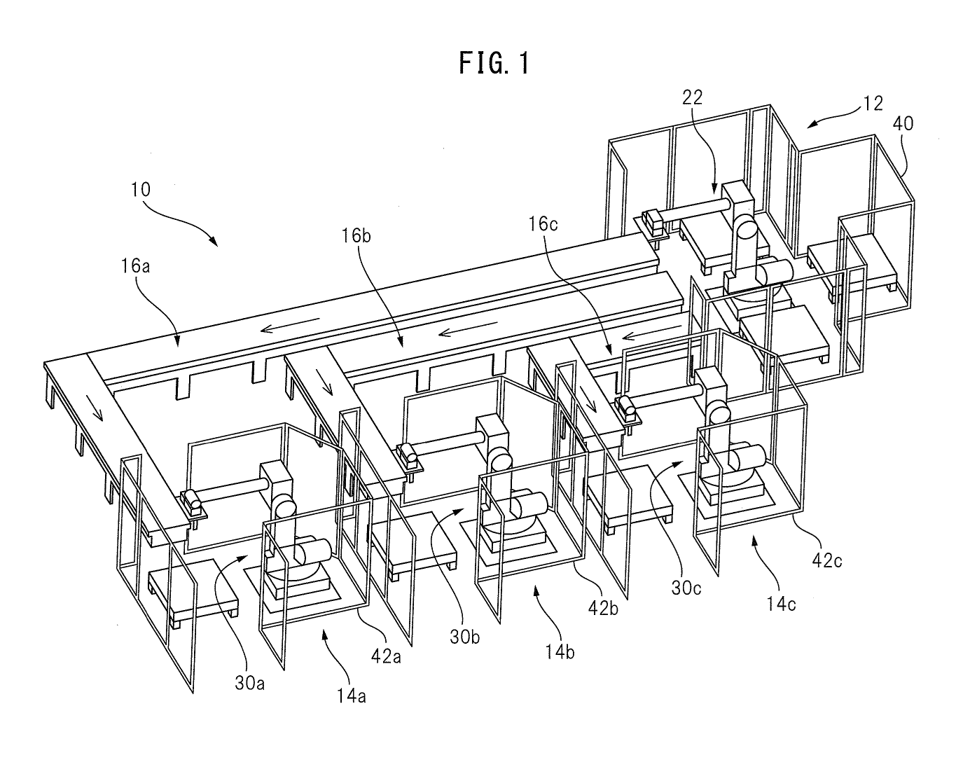

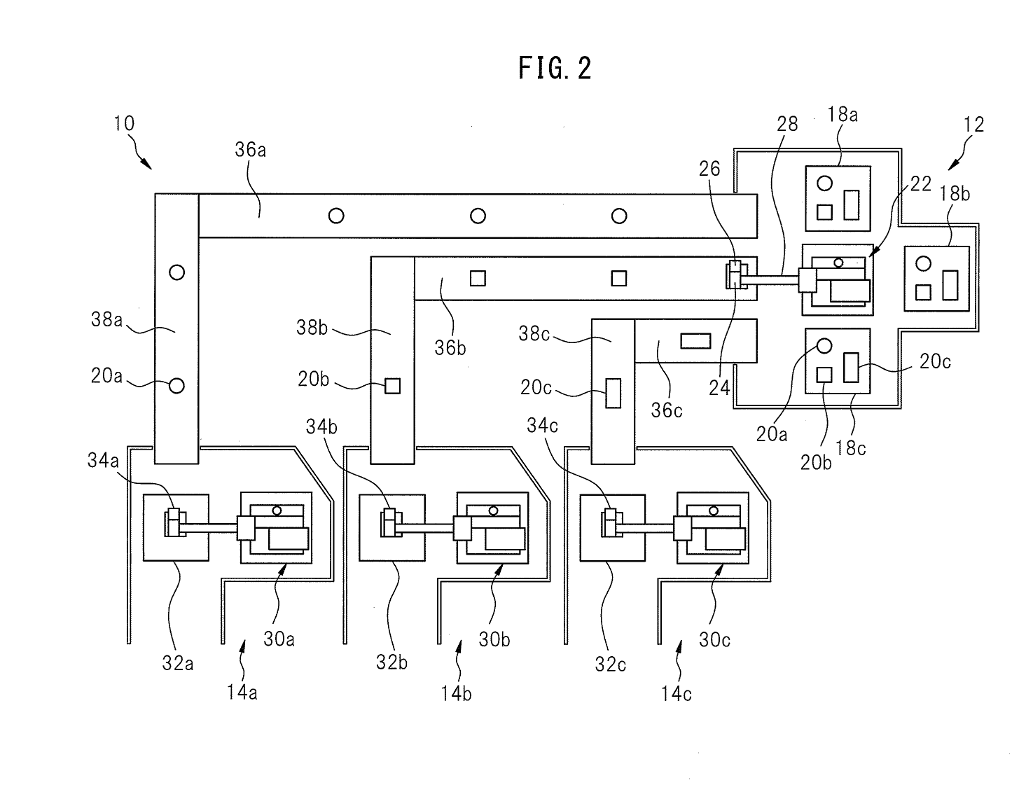

FIG. 1 is a perspective view showing a robot operation system according to a first embodiment of the present invention, and FIG. 2 is a top view thereof. A robot operation system 10 includes one component supplying unit 12; a plurality of (three in the illustrated embodiment) operation units 14a, 14b and 14c; and component conveying devices 16a, 16b and 16c which respectively connect operation units 14a, 14b and 14c to component supplying unit 12 and respectively convey a component to operation units 14a, 14b and 14c. Concretely, component supplying unit 12 and operation unit 14a are connected by component conveying device 16a, component supplying unit 12 and operation unit 14b are connected by component conveying device 16b, and component supplying unit 12 and operation unit 14 are connected by component conveying device 16c.

Component supplying unit 12 is adapted to supply a component to each of operation units 14a, 14b and 14c. Component supplying unit 12 includes pallets 18a, 18b and 18c on which components used in respective operation units are disposed, and at least one (one in the illustrated embodiment) supplying robot 22 for taking out components 20a, 20b and 20c on the pallets (see FIG. 2) and transferring the component to the corresponding conveying device. Concretely, supplying robot 22 is a multi-joint robot having six axes, and has a robot hand 24 configured to grip or hold each component. Robot 22 may grip or hold a component positioned on the pallet located around robot 22 based on previously stored positional information of each component on the pallet, and may transfer the component to any one of component conveying devices 16a, 16b and 16c. In the illustrated embodiment, operation units 14a, 14b and 14c handle components 20a, 20b and 20c, respectively, and components 20a, 20b and 20c are conveyed by component conveying devices 16a, 16b and 16c, respectively.

Component supplying unit 12 may have a vision sensor 26 for detecting the position and orientation of each component on pallets 18a, 18b and 18c. In the illustrated embodiment, vision sensor 26 has a camera arranged on a movable part of robot 22 (for example, a front end of robot arm 28) so that the vision sensor may obtain an image of each component on the pallet (or the entire pallet) due to the motion of each axis of robot 22. The obtained image is processed by an image processor (not shown), whereby the position and orientation of each component on the pallet can be determined. A detection result obtained as such may be used to correct the above positional information, whereby robot 22 can take out the component more precisely.

When vision sensor 26 is used, various components may be randomly located on the pallet. In this case, vision sensor 26 captures an image of the entire pallet, the obtained image is processed, and the position and orientation of each component on the pallet are detected, whereby robot 22 can take out the component based on the detection result.

Operation unit 14a has at least one (one in the illustrated embodiment) operation robot 30a which is configured to perform an operation (machining, welding or assembling, etc.) regarding component 20a conveyed by conveying device 16a. In addition, operation unit 14a may have a working table 32a on which component 20a from conveying device 16a is positioned, whereby operation robot 30a can perform a predetermined operation with respect to the component on working table 32a. Further, operation robot 30a may be provided with a vision sensor 34a having a function equivalent to vision sensor 26 as described above, whereby the position and orientation of the component, which is conveyed by conveying device 16a and positioned on working table 32a, can be detected by vision sensor 34a.

Similarly, operation unit 14b has at least one (one in the illustrated embodiment) operation robot 30b which is configured to perform an operation (machining, welding or assembling, etc.) regarding component 20b conveyed by conveying device 16b. In addition, operation unit 14b may have a working table 32b on which component 20b from conveying device 16b is positioned, whereby operation robot 30b can perform a predetermined operation with respect to the component on working table 32b. Further, operation robot 30b may be provided with a vision sensor 34b having a function equivalent to vision sensor 26 as described above, whereby the position and orientation of the component, which is conveyed by conveying device 16b and positioned on working table 32b, can be detected by vision sensor 34b.

Similarly, operation unit 14c has at least one (one in the illustrated embodiment) operation robot 30c which is configured to perform an operation (machining, welding or assembling, etc.) regarding component 20c conveyed by conveying device 16c. In addition, operation unit 14c may have a working table 32c on which component 20c from conveying device 16c is positioned, whereby operation robot 30c can perform a predetermined operation with respect to the component on working table 32c. Further, operation robot 30c may be provided with a vision sensor 34c having a function equivalent to vision sensor 26 as described above, whereby the position and orientation of the component, which is conveyed by conveying device 16c and positioned on working table 32c, can be detected by vision sensor 34c.

Component conveying device 16a is configured to connect operation unit 14a to component supplying unit 12, and convey component 20a, supplied from the component supplying unit, to operation unit 14a. In the first embodiment, component conveying device 16a is a belt conveyor. In particular, the belt conveyor is constituted by two linear belt conveyors 36a and 38a wherein the longitudinal directions thereof are generally orthogonal to each other.

Similarly, component conveying device 16b is configured to connect operation unit 14b to component supplying unit 12, and convey component 20b, supplied from the component supplying unit, to operation unit 14b. In the first embodiment, component conveying device 16b is a belt conveyor. In particular, the belt conveyor is constituted by two linear belt conveyors 36b and 38b wherein the longitudinal directions thereof are generally orthogonal to each other.

Component conveying device 16c is configured to connect operation unit 14c to component supplying unit 12, and convey component 20c, supplied from the component supplying unit, to operation unit 14c. In the first embodiment, component conveying device 16c is a conveyor such as a belt conveyor or a roller conveyor. In particular, the conveyor is constituted by two linear conveyors 36c and 38c wherein the longitudinal directions thereof are generally orthogonal to each other.

When the component conveying device is constituted by the conveyor as in the first embodiment, the linear conveyors may be combined so as to form an L-shape as described above, for example. Therefore, the component may be conveyed or supplied in an arbitrary direction, whereby a flexible operation system can be constituted at low cost, corresponding to the positional relationship between the component supplying unit and each operation unit.

In the illustrated embodiment, component supplying unit 12 and operation units 14a, 14b and 14c are partitioned from each other by means of safety fences 40, 42a, 42b and 42c, etc. However, these fences are not essential to the present invention.

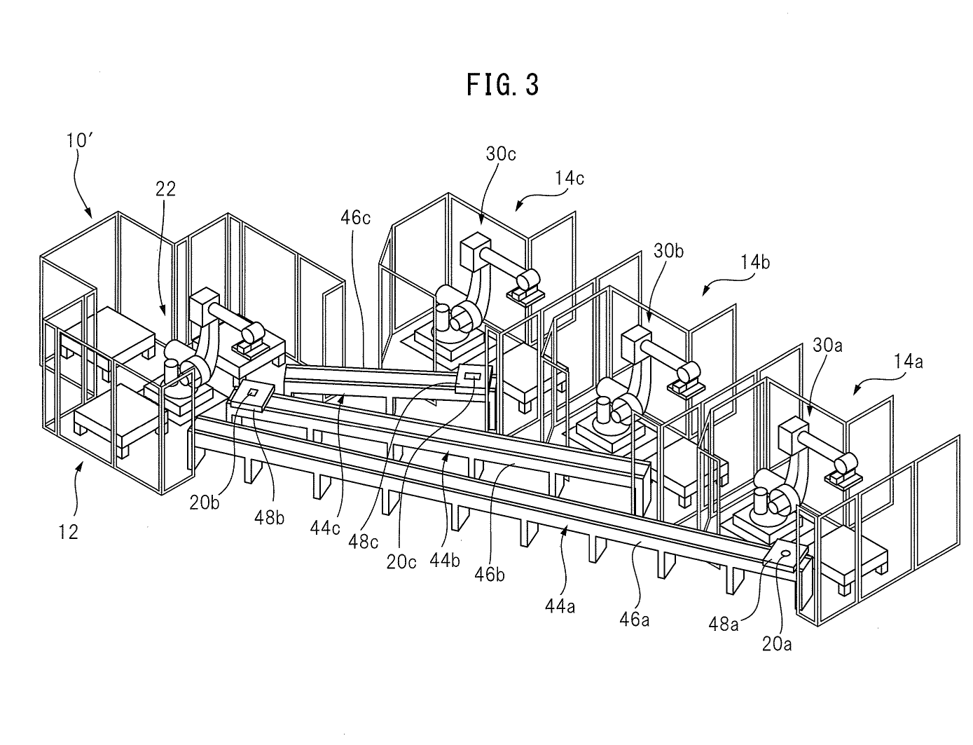

FIG. 3 is a perspective view showing a robot operation system according to a second embodiment of the present invention. In a robot operation system 10′ of the second embodiment, the configuration of a component conveying device is different from that of the first embodiment. On the other hand, since the other elements (i.e., one component supplying unit 12, and the plurality of (three in the illustrated embodiment) operation units 14a, 14b and 14c) may be the same as the first embodiment, a detailed explanation thereof will be omitted.

A component conveying device 44a in the second embodiment is configured to connect operation unit 14a to component supplying unit 12, and convey component 20a supplied from the component supplying unit to operation unit 14a. In the second embodiment, component conveying device 44a is a slider such as a linear slider, in detail, has a linear rail 46a and a movable table 48a which is movable on rail 46a. Due to such a configuration, when movable table 48a is positioned at an end of rail 46a near component supplying unit 12, a series of operations (i.e., supplying robot 22 locates component 20a on movable table 48a; movable table 48a is moved to an end of rail 46a near operation unit 14a; and operation robot 30a performs a predetermined operation) can be carried out.

Similarly, a component conveying device 44b is configured to connect operation unit 14b to component supplying unit 12, and convey component 20b supplied from the component supplying unit to operation unit 14b. In the second embodiment, component conveying device 44b is a slider such as a linear slider, in detail, has a linear rail 46b and a movable table 48b which is movable on rail 46b. Due to such a configuration, when movable table 48b is positioned at an end of rail 46b near component supplying unit 12, a series of operations (i.e., supplying robot 22 locates component 20b on movable table 48b; movable table 48b is moved to an end of rail 46b near operation unit 14b; and operation robot 30b performs a predetermined operation) can be carried out.

Similarly, a component conveying device 44c in the second embodiment is configured to connect operation unit 14c to component supplying unit 12, and convey component 20c supplied from the component supplying unit to operation unit 14c. In the second embodiment, component conveying device 44c is a slider such as a linear slider, in detail, has a linear rail 46c and a movable table 48c which is movable on rail 46c. Due to such a configuration, when movable table 48c is positioned at an end of rail 46c near component supplying unit 12, a series of operations (i.e., supplying robot 22 locates component 20c on movable table 48c; movable table 48c is moved to an end of rail 46c near operation unit 14c; and operation robot 30c performs a predetermined operation) can be carried out.

As each linear slider as described above, for example, an air-driven slider, a servo-drive slider or a slider driven by a linear motor, may be used. When the air-driven slider is used, the linear slider may be constituted at low cost. When the servo-drive slider is used, the linear slider may convey the component rapidly and precisely. Otherwise, when the slider driven by the linear motor is used, the linear slider may convey the component rapidly and precisely, and moreover, operational noise of the slider may be reduced.

In the illustrated embodiments, different components may be supplied to respective operation units, and the respective operation units may carry out different operations. However, the same component may be supplied to each operation unit, and each operation unit may carry out the same operation. In any case, it is preferable that the operation units be partitioned from each other by means of safety fences, etc., so that the motion of one robot does not limit or interfere with the motion of another robot.

According to the present invention, by connecting one component supplying unit and each operation unit by means of the component conveying device, the component can be supplied to many units with fewer operators. Further, since the components can be conveyed individually and sequentially, a pallet for the components can be simplified.

By carrying out the supplying operation at the component supplying unit by using the supplying robot, man-hours required for the supplying operation can be reduced.

By carrying out the supplying operation at the component supplying unit by using an intelligent robot having a vision sensor, a device or workload required to precisely position the component on the pallet can be eliminated or reduced.

The supplying operation of the component from the component supplying unit to each operation unit can be carried out by means of a conventional device such as a linear slider or a belt conveyor.

While the invention has been described with reference to specific embodiments chosen for the purpose of illustration, it should be apparent that numerous modifications could be made thereto, by a person skilled in the art, without departing from the basic concept and scope of the invention.

1. An operation system including a plurality of operation units, each operation unit having a robot configured to carry out a predetermined operation, the operation system comprising:
one component supplying unit which supplies a component to each operation unit; and
a component conveying device which connects the one component supplying unit and each operation unit and conveys the component supplied from the one component supplying unit to each operation unit.

2. The operation system as set forth in claim 1, wherein the component supplying unit comprises a supplying robot which is operated by using previously stored positional information, the supplying robot being configured to transfer a component to the component conveying device.

3. The operation system as set forth in claim 2, wherein the supplying robot comprises a vision sensor, and the supplying robot is operated by correcting the stored positional information based on information from the vision sensor.

4. The operation system as set forth in claim 1, wherein the component conveying device is an air-driven slider.

5. The operation system as set forth in claim 1, wherein the component conveying device is a servo-drive slider.

6. The operation system as set forth in claim 1, wherein the component conveying device is a slider driven by a linear motor.

7. The operation system as set forth in claim 1, wherein the component conveying device is a belt conveyor.
